(19) United States
(12) Patent Application Publication
(10) Pub. No.: US 2011/0296439 A1
(43) Pub. Date: Dec. 1, 2011

(54) INFORMATION PROCESSING DEVICE, APPLICATION EXECUTION METHOD, AND COMPUTER READABLE MEDIUM

(75) Inventor: Yousuke KOZAKI, Amagasaki-shi (JP)

(73) Assignee: Konica Minolta Business Technologies, Inc., Chiyoda-ku (JP)

(21) Appl. No.: 13/114,228

(22) Filed: May 24, 2011

(30) Foreign Application Priority Data
May 25, 2010 (JP) 2010-118897

(51) Int. Cl. G06F 9/46

(52) U.S. Cl. 719/318

(57) ABSTRACT

An information processing device, comprises: a storage part for storing a plurality of application programs allowing a specified function to operate under operating conditions differ among the plurality of application programs; a configuration part for configuring a setting to reflect the operating conditions corresponding to one application program selected from the plurality of application programs; an application management part for managing the respective operating conditions of the plurality of application programs, for obtaining a current setting configured by the configuration part when allowing the specified function to operate and for selecting, based on the respective operating conditions of the plurality of application programs, the one application program takes the shortest amount of processing time required for an operating conditions reflection executed by the configuration part; and an application execution part for allowing the specified function to operate with execution of the one application program selected by the application management part.

This application is based on the application No. 2010-118897 filed in Japan, the contents of which are hereby incorporated by reference.

### BACKGROUND OF THE INVENTION

1. Field of the Invention

The present invention relates to an information processing device, an application program execution method, and a computer readable medium. The present invention more specifically relates to a technique of selecting one application program of a plurality of application programs when the plurality of application programs for allowing a specified function to operate under operating conditions differ among the plurality of application programs are installed on an information processing device.

2. Description of the Background Art

Information processing devices called as MFPs (multi function peripherals) placed in an office environment have multiple functions including a function for copying, printing, scanning and faxing. This type of conventional information processing device stores therein a standard program for allowing each function to operate installed in advance. As the user operates to select one of the functions, the standard program is executed in the information processing device. The function selected by the user operates in the information processing device, and a job is executed.

In recent years, in order to promote diversification of solution deployment with use of the information processing device, the information processing device has been capable of storing therein an application program installed separately. The application program is different from the standard program. This known technique is introduced for example in Japanese Patent Application Laid-Open No. JP2004-129246 A and in Japanese Patent Application Laid-Open No. JP2009-93228 A.

The above-described application program is sometimes created as a program for executing a process specified for a particular status of the information processing device, for example. The application program may also be created as a program which provides a function not supported with the standard program. As the application program being installed on the information processing device, the application program executed to allow each function such as that for copying, printing, scanning and faxing to operate becomes diversified. To be more specific, sometimes a plurality of application programs capable of being executed for allowing a specified function such as that for copying to operate are installed rather than one application program. In such a case, each of the application programs is, for example, executed under different operating conditions in the information processing device, thereby allowing the specified function of the information processing device to operate.

As described above, it is assumed that the plurality of application programs allowing the specified function to operate under the operating conditions differ among the plurality of application programs are installed on the information processing device. In such a case, the amount of time is required for the application program to start (hereafter, start-up time of the application program) can vary depending on the application program selected by the user. When, for example, the operating conditions of the application program selected by the user have matched a current status of the information processing device, a process to reflect the operating conditions is not necessary at start-up of the application program. In this case, the amount of start-up time of the application program is relatively short.

When the operating conditions of the application program selected by the user have not match the current status of the information processing device, the process to reflect the operating conditions (hereafter, operating conditions reflection) is executed at the start-up of the application program. The operating conditions reflection requires a predetermined amount of processing time. The user is made to wait for a long time for the application program to be started normally and the specified function to be available in the information processing device. Some set values updated with the operating conditions reflection require restart of the information processing device. The user's waiting time gets much longer, and a convenience of the information processing device declines.

The application program matching the current status of the information processing device needs to be selected to shorten the start-up time of the application program. It is difficult for the user to know the current status (such as a status of settings) of the information processing device. So, it is hard for the user to find which application program he or she should select from the plurality of application programs.

Also, sometimes, the user would like to make each of the multiple functions of the information processing device operate sequentially with the information processing device. It is assumed, for example, the user would like his or her document to be read with the scanner function of the information processing device and the read document to be converted to text with an OCR (optical character reader) function of the information processing device. The operating conditions of the application program allowing the first scanner function to operate and those of the application program allowing the second OCR function to operate can be different if the application program corresponding to each function is selected freely by the user in the above-described case. In this case, the above-described operating conditions reflection is executed at start-up of the second application program after execution of the first application program. The multiple functions are not operating smoothly in series. Also, it is assumed that a data format output with the scanner function and a data format readable with the OCR function are not the same. In this case, the document may require to be read again in the data format readable with the OCR function to allow the OCR function to operate normally. In order to make the reading operation of the document again, the user needs to place the document again on a scanner unit, resulting in extremely declined operability.

### SUMMARY OF THE INVENTION

The present invention is intended to solve the above problems. Thus, the present invention is intended to provide an information processing device, an application execution method and a computer readable medium capable of shortening a time waiting for an application program to start up and improving convenience and operability. The information processing device, the application execution method and the computer readable medium are capable of realizing the convenience and operability even when operating conditions of each application program are unclear for a user as the plurality of application programs, each of them allowing a specified function to operate, have been installed.

First, the present invention is directed to an information processing device.

According to one aspect of the information processing device, the information processing device, comprises: a storage part for storing a plurality of application programs allowing a specified function to operate under operating conditions differ among the plurality of application programs; a configuration part for configuring a setting to reflect the operating conditions corresponding to one application program selected from the plurality of application programs; an application management part for managing the respective operating conditions of the plurality of application programs, for obtaining a current setting configured by the configuration part when allowing the specified function to operate and for selecting, based on the respective operating conditions of the plurality of application programs, the one application program which takes the shortest amount of processing time required for an operating conditions reflection executed by the configuration part; and an application execution part for allowing the specified function to operate with execution of the one application program selected by the application management part.

Second, the present invention is directed to an information processing device executes a series of processes by allowing a first function and a second function to operate sequentially.

According to one aspect of the information processing device, the information processing device, comprises: a storage part for storing a plurality of first application programs allowing the first function to operate under operating conditions differ among the plurality of first application programs and a plurality of second application programs allowing the second function to operate under operating conditions differ among the plurality of second application programs; a configuration part for configuring a setting to reflect the operating conditions corresponding to one first application program selected from the plurality of first application programs for allowing the first function to operate and for configuring a setting to reflect the operating conditions corresponding to one second application program selected from the plurality of second application programs for allowing the second function to operate; an application management part for managing the respective operating conditions of the plurality of first application programs and the plurality of second application programs, for obtaining in advance a current setting configured by the configuration part when allowing the first function and the second function to operate sequentially and for selecting, based on the respective operating conditions of the plurality of first application programs and the plurality of second application programs, one combination of the one first application program and the one second application program which takes the shortest amount of total processing time required for an operating conditions reflection executed by the configuration part for allowing the first function to operate and an operating conditions reflection executed by the configuration part for allowing the second function to operate; and an application execution part for allowing the first function to operate with execution of the one first application program and for allowing the second function to operate with execution of the one second application program after operation of the first function based on the one combination selected by the application management part.

Third, the present invention is directed to an application execution method.

According to an aspect of the application execution method, the application execution method, comprises the steps of: (a) storing a plurality of application programs allowing a specified function to operate under operating conditions differ among the plurality of application programs; (b) managing the respective operating conditions of the plurality of application programs, obtaining a current setting corresponding to the specified function for allowing the specified function to operate and selecting, based on the respective operating conditions of the plurality of application programs, one application program which takes the shortest amount of processing time required for an operating conditions reflection executed to allow the specified function to operate; (c) configuring a setting to reflect the operating conditions corresponding to the one application program selected from the plurality of application programs; and (d) allowing the specified function to operate with execution of the one application program selected from the plurality of application programs.

Forth, the present invention is directed to an application execution method for executing a series of processes by executing each application program corresponding to a first function and a second function sequentially.

According to one aspect of the application execution method, the application execution method, comprises the steps of: (a) storing a plurality of first application programs allowing the first function to operate under operating conditions differ among the plurality of first application programs and a plurality of second application programs allowing the second function to operate under operating conditions differ among the plurality of second application programs; (b) managing the respective operating conditions of the plurality of first application programs and the plurality of second application programs, obtaining in advance a current setting corresponding to each of the first function and the second function when the first function and the second function are allowed to operate sequentially and selecting, based on the respective operating conditions of the plurality of first application programs and the plurality of second application programs, one combination of one first application program and one second application program which takes the shortest amount of total processing time required for an operating conditions reflection executed for allowing the first function to operate and an operating conditions reflection executed for allowing the second function to operate; (c) configuring a setting to reflect the operating conditions corresponding to the one first application program of the one combination for allowing the first function to operate and for configuring a setting to reflect the operating conditions corresponding to one second application program of the one combination for allowing the second function to operate; and (d) allowing the first function to operate with execution of the one first application program of the one combination and for allowing the second function to operate with execution of the one second application program of the one combination after operation of the first function.

Fifth, the present invention is directed to a computer readable recording medium on which an application management program is recorded. The application management program selects one application program of a plurality of application programs in an information processing device on which the plurality of application programs allowing a specified function to operate under operating conditions differ among the plurality of application programs when allowing the specified function to operate are installed.

According to an aspect of the computer readable recording medium, the application management program recorded on the recording medium causes the information processing device to execute the steps of: (a) configuring a setting to reflect the operating conditions corresponding to the one application program selected from the plurality of application programs; (b) managing the respective operating conditions of the plurality of application programs, obtaining a current setting configured in the step (a) when the specified function is allowed to operate and selecting, based on the respective operating conditions of the plurality of application programs, one application program which takes the shortest amount of processing time required for an operating conditions reflection executed in the step (a); and (c) allowing the specified function to operate with execution of the one application program selected in the step (b).

Sixth, the present invention is directed to a computer readable recording medium on which an application management program is recorded. The application management program selects one of a plurality of first application programs and one of a plurality of second application programs in an information processing device on which the plurality of first application programs allowing a first function to operate under operating conditions differ among the plurality of first application programs and the plurality of second application programs allowing a second function to operate under operating conditions differ among the plurality of second application programs are installed when allowing the first function and the second function to operate sequentially.

According to an aspect of the computer readable recording medium, the application management program recorded on the recording medium causes the information processing device to execute the steps of: (a) configuring a setting to reflect the operating conditions corresponding to the one first application program selected from the plurality of first application programs for allowing the first function to operate and for configuring a setting to reflect the operating conditions corresponding to the one second application program selected from the plurality of second application programs for allowing the second function to operate; (b) managing the respective operating conditions of the plurality of first application programs and the plurality of second application programs, obtaining in advance a current setting configured in the step (a) when the first function and the second function are allowed to operate sequentially and selecting, based on the respective operating conditions of the plurality of first application programs and the plurality of second application programs, one combination of the one first application program and the one second application program which takes the shortest amount of total processing time required for an operating conditions reflection executed in the step (a) for allowing the first function to operate and an operating conditions reflection executed in the step (a) for allowing the second function to operate; and (c) allowing the first function to operate with execution of the one first application program and for allowing the second function to operate with execution of the one second application program after operation of the first function based on the one combination selected in the step (b).

### BRIEF DESCRIPTION OF THE DRAWINGS

FIG. 1 shows an exemplary network configuration in which an information processing device is included;

FIG. 2 is a block diagram showing the hardware configuration of an information processing device;

FIG. 3 is a block diagram showing the system configuration of the information processing device when a CPU starts a system program and an application management program;

FIG. 4 shows an example of a function selection screen displayed on a display unit;

FIG. 5 is an example of a detailed setting screen relating to a scan function;

FIG. 6 is an example of a detailed setting screen relating to an OCR function;

FIG. 7 shows an example of operating conditions management information managed by an application management part;

FIG. 8 shows an example of a reference table referred to by the application management part;

FIG. 9 conceptually shows the process with each of four patters of a combination which allows the scan function and the OCR function to operate sequentially;

FIG. 10 shows an example of an application selection screen;

FIG. 11 conceptually shows the process executed by each of a plurality of first application programs for allowing a single function to operate;

FIG. 12 is a flow diagram explaining the process sequence of a process executed by the CPU of the information processing device;

FIG. 13 is a flow diagram explaining in detail an exemplary process sequence of a combination selecting process;

FIG. 14 is a flow diagram explaining in detail an exemplary process sequence of a recommended pattern selecting process;

FIG. 15 is a flow diagram explaining in detail an exemplary process sequence of the recommended pattern selecting process;

FIG. 16 is a flow diagram explaining in detail an exemplary process sequence of an application selecting process; and

FIG. 17 is a flow diagram explaining in detail an exemplary process sequence of the application selecting process.

### DESCRIPTION OF THE PRESENT PREFERRED EMBODIMENTS

A present preferred embodiment of the present invention is described in detail below with reference to figures. In the description given below, those elements which are shared in common among figures are represented by the same reference numerals, and these elements are not discussed repeatedly for the same description.

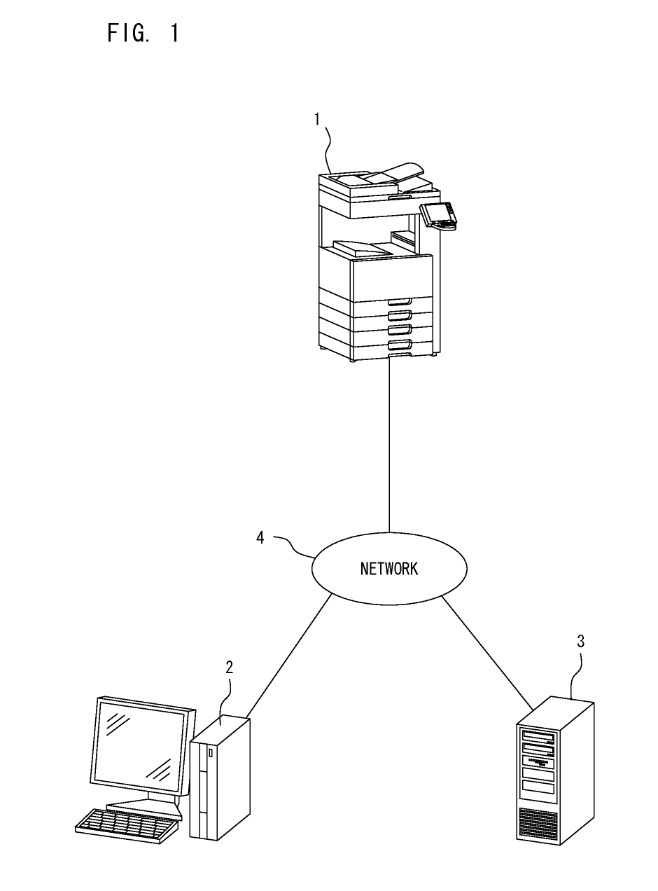

FIG. 1 shows an exemplary network configuration in which an information processing device 1 installed at a place such as an office environment is included. The information processing device 1 is connected with a computer 2 and a server 3 through a network 4. Other devices may also be connected to the network 4. The server 3 is a server such as a web server and a file server.

The information processing device 1 is an MFP (multi function peripheral) with multiple functions such as a copy function, a printer function, a scanner function, a fax function, a box function and an OCR (optical character reader) function. Each of the functions is not in an operating status all the time in the information processing device 1. The function operates in response to an operation to select the function made by the user, for example.

The copy function is to read a document and produce a copied matter of the read document. The print function is to produce a printed matter based on data input from the computer 2 through the network 4. The scan function is to store image data generated by reading a document in a predetermined storage device. The scan function enables the image data generated by reading the document being transmitted to the computer 2 or the server 3 through the network 4. The fax function is to transmit and receive fax data through a fax network which is not shown in FIG. 1. The box function is to store data in a predetermined storage region and to read the data stored in the predetermined storage region. The OCR function is to extract characters contained in image data, thereby converting to text.

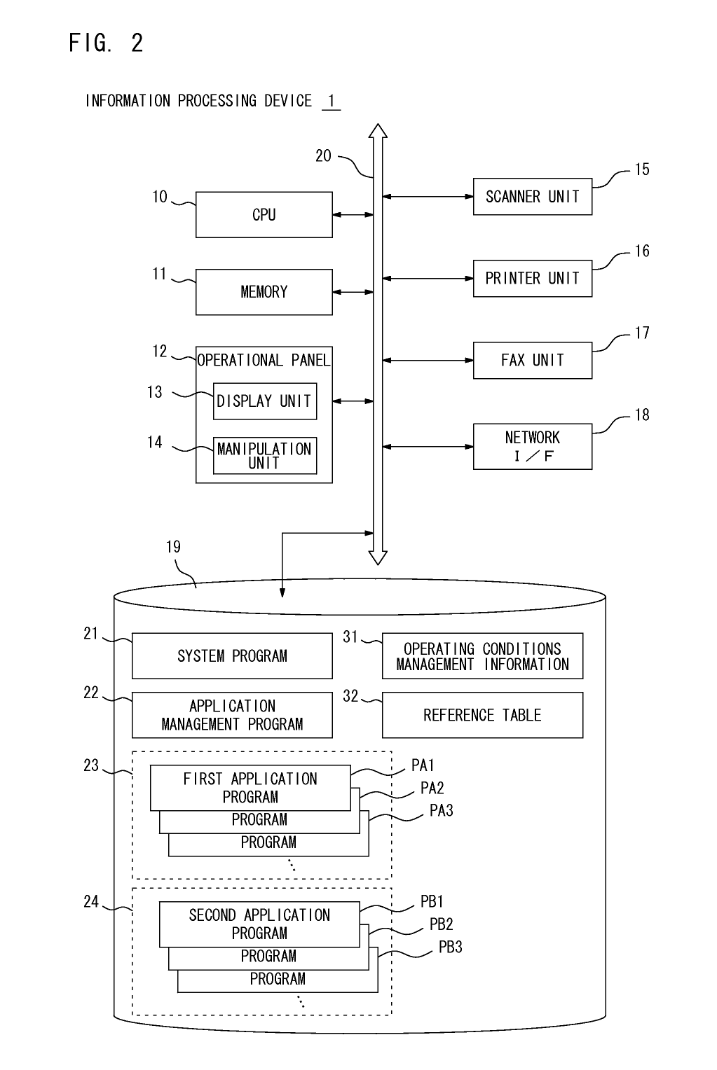

FIG. 2 is a block diagram showing the hardware configuration of the information processing device 1. The information processing device 1 includes a CPU 10, a memory 11, an operational panel 12, a scanner unit 15, a printer unit 16, a fax unit 17, a network interface 18 and a storage device 19 that are connected to each other to allow data input and output between these parts through a data bus 20. The CPU 10 executes a variety of programs. The memory 11 stores therein data such as temporary data with execution of the program by the CPU 10. The operational panel 12 which is a user interface when the information processing device 1 is operated by a user. The scanner unit 15 reads a document. The printer unit 16 produces a printed matter. The fax unit 17 transmits and receives fax data. The network interface 18 is for connecting the information processing device 1 to the network 4, and the storage device 19 is a device such as a hard disk drive. The operational panel 12 includes a display unit 13 on which various types of information are displayed and a manipulation unit 14 which receives a range of operations to specify made by the user. The display unit 13 is formed from a device such as a liquid crystal display. The manipulation unit 14 has a plurality of operation keys including both touch panel keys arranged on a screen of the display unit 13 and push-button keys arranged around the screen. The push-button keys include a start key to give an instruction on execution of a job, for example.

The storage device 19 stores therein each program and/or information installed in advance on the information processing device 1. Also, a variety of storage regions for use of the box function are configured. FIG. 2 shows an example of the programs and information stored in the storage device 19.

As shown in FIG. 2, the storage device 19 stores therein a system program 21, an application management program 22, a first application program group 23 and a second application program group 24. The operating system of the information processing device 1 is consisting of the system program 21, a basic program. The application management program 22 executes a process for managing a plurality of application programs of the first application program group 23 and the second application program group 24.

The CPU 10 reads and executes the system program 21 when the information processing device 1 is turned on, thereby starting the system program 21. With the start-up of the system program 21, the CPU 10 starts the application management program 22. In FIG. 2, the application management program 22 and the system program 21 seem to be different programs. The application management program 22 may also be the program forming a part of the system program 21.

The first application program group 23 executes a process corresponding to a specified function of the information processing device 1. The specified function is one of the multiple functions including the copy function, the print function, the scan function, the fax function, the box function and the OCR function. In the present preferred embodiment, for example, the first application program group 23 executes a process corresponding to the scan function.

The first application program group 23 includes a plurality of the first application programs PA1, PA2 and PA3. Each of the plurality of the first application programs PA1, PA2 and PA3 is executed to allow the scan function to operate in the information processing device 1. Each of the plurality of the first application programs PA1, PA2 and PA3 has different operating conditions for the scan function allowed by each of the plurality of the first application programs PA1, PA2 and PA3 to operate in the information processing device 1. As an example, each of the plurality of the first application programs PA1, PA2 and PA3 has different operating conditions such as a data format of image data generated by reading a document and a data transmission method (including a communications protocol) for transmitting the image data to the outside computer 2 or the server 3.

The second application program group 24 executes a process corresponding to a specified function of the information processing device 1. The specified function is one of the multiple functions including the copy function, the print function, the scan function, the fax function, the box function and the OCR function. In the present preferred embodiment, for example, the second application program group 24 executes a process corresponding to the OCR function.

The second application program group 24 includes a plurality of the second application programs PB1, PB2 and PB3. Each of the plurality of the second application programs PB1, PB2 and PB3 is executed to allow the OCR function to operate in the information processing device 1. Each of the plurality of the second application programs PB1, PB2 and PB3 has different operating conditions for the OCR function allowed by each of the plurality of the second application programs PB1, PB2 and PB3 to operate in the information processing device 1. As an example, each of the plurality of the second application programs PB1, PB2 and PB3 has different operating conditions such as a data format readable for extraction of characters, a saving format for storing data converted to text and a data transmission method (including a communications protocol) for transmitting the data converted to text to the outside computer 2 or the server 3.

The storage device 19 stores therein application program groups corresponding to the respective functions, the copy function, the print function, the fax function and the box function besides the plurality of the first application programs PA1, PA2 and PA3 and the second application programs PB1, PB2 and PB3. Those application program groups are not shown in FIG. 2 and not explained in the present preferred embodiment.

The storage device 19 also stores therein operating conditions management information 31. The operating conditions management information 31 defines the respective operating conditions of the programs included in the first application program group 23 and the second application program group 24. The storage device 19 also stores therein a reference table 32. The reference table 32 contains information and time taken for a process (hereafter, processing time) executed in the information processing device 1 to reflect the respective operating conditions of the programs. The operating conditions management information 31 and the reference table 32 are described in detail later.

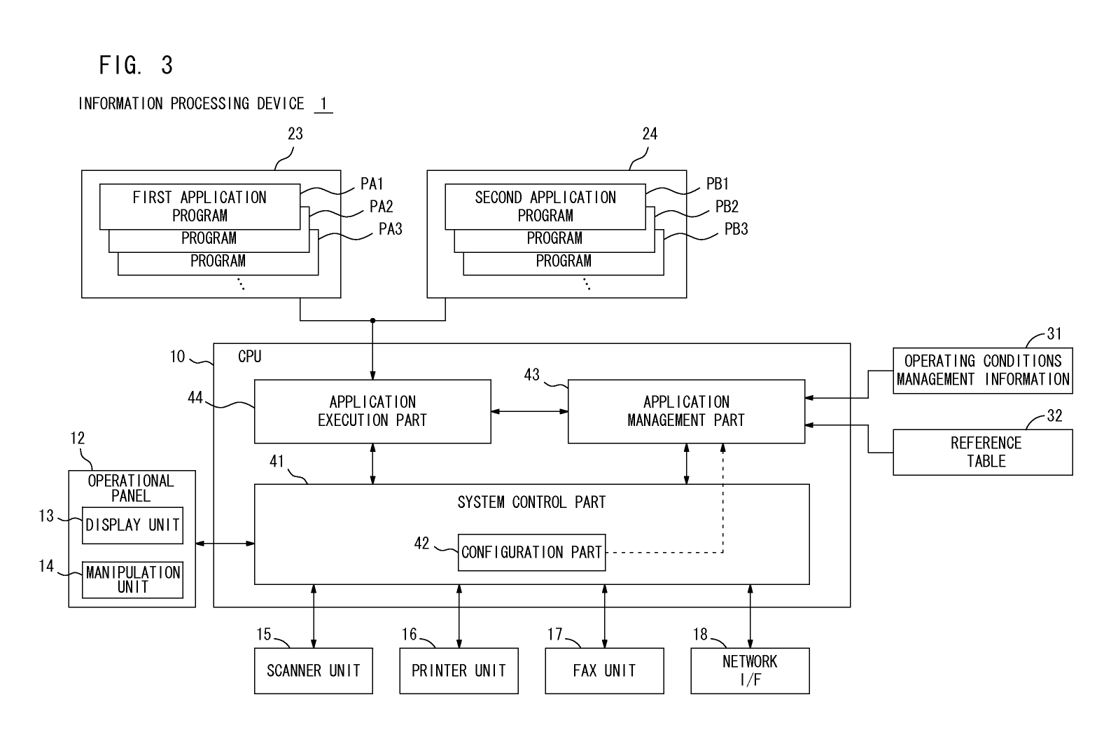

FIG. 3 is a block diagram showing the system configuration of the information processing device 1 when the CPU 10 starts the system program 21 and the application management program 22. After the information processing device 1 is turned on, the CPU 10 reads and executes the system program 21 and the application management program 22 stored in the storage device 19 as described above. The CPU 10 is put into operation to function as a system control part 41, an application management part 43 and an application execution part 44.

The system control part 41 is put into operation by execution of the system program 21, and controls the operational panel 12, the scanner unit 15, the printer unit 16, the fax unit 17 and the network interface 18. The system control part 41 works together with the application management part 43 and the application execution part 44, thereby controlling each part.

The application management part 43 is put into operation by execution of the application management program 22, and selects the application program for the application execution part 44 to execute based on the function selected by the user. The application management part 43 refers to the operating conditions management information 31 and the reference table 32 to select the application program.

The application execution part 44 is put into operation mainly by execution of the system program 21, and reads and executes the application program selected by the application management part 43. The application program is read from the storage device 19. The application execution part 44 executes one application program, and the function specified by the user operates in the information processing device 1.

The application execution part 44 reads and executes, for example, one of the plurality of the first application programs PA1, PA2 and PA3 of the first application program group 23, and the scanner function operates in the information processing device 1. When the scanner function operates, the application execution part 44 controls the scanner unit 15 via the system control part 41. The scanner unit 15 is caused to execute an operation to read the document to obtain image data. Based on the image data obtained through the scanner unit 15, the application execution part 44 generates image data in a predetermined data format. The application execution part 44 then controls the network interface 18 via the system control part 41 to transmit the image data in the predetermined data format to the outside computer 2 or the server 3 if necessary.

The application execution part 44 reads and executes, for example, one of the plurality of the second application programs PB1, PB2 and PB3 of the second application program group 24, and the OCR function operates in the information processing device 1. When the OCR function operates, the application execution part 44 obtains image data from which characters are extracted via the system control part 41. The application execution part 44 then executes character extraction from the obtained image data, thereby converting the image data to text and generating text data in a predetermined data format. The application execution part 44 controls the network interface 18 via the system control part 41 to transmit the text data in the predetermined data format to the outside computer 2 or the server 3 if necessary.

As described above, in the present preferred embodiment, after the information processing device 1 is turned on, the system program 21 and the application management program 22 are started by the CPU 10. In the state that the programs are started, the multiple functions including the copy function, the print function, the scan function, the fax function, the box function and the OCR function are in an initial state in which any of the functions has not been operated yet. In the initial state, the system control part 41 displays a function selection screen through the display unit 13 of the operational panel 12, thereby receiving an operation to select a function (hereafter, function selecting operation) by the user. After receiving the function selecting operation by the user, the application management part 43 selects one application program from the plurality of application programs corresponding to the selected function. The application management part 43 then makes the selected application program execute through the application execution part 44. The function of the multiple functions including the copy function, the print function, the scan function, the fax function, the box function and the OCR function selected by the user operates in the information processing device 1, and the job is executed with the process executed by the application execution part 44.

The system control part 41 includes a configuration part 42. The configuration part 42 executes a predetermined configuration process to reflect the operating conditions of the application program executed by the application execution part 44. It is assumed, for example, that the application program executed by the application execution part 44 contains the instruction to transmit data via the network interface 18 with the specified data transmission method (including the communications protocol). In this case, the application execution part 44 outputs a command designating the specified data transmission method to the system control part 41 when starting the application program. Based on the command output by the application execution part 44, the configuration part 42 reconfigures the setting of the network interface 18 or rewrites an internal parameter of the system control part 41. As a result, the configuration part 42 changes the setting of each part to match the operating conditions of the application program started by the application execution part 44.

The configuration part 42 constantly manages settings corresponding to each part such as the respective internal parameters of the scanner unit 15, the printer unit 16, the fax unit 17, the network interface 18 and the system control part 41. In response to receipt of the command designating operating conditions of the application program from the application execution part 44 at start-up of the application program, the configuration part 42 determines whether or not the current setting of each part matches the operating conditions designated with the command. If the current setting determined to be matched, the process to reflect the operating conditions is not executed. More specifically, the process to reflect the operating conditions as described above is executed only if the current setting of each part does not match the operating conditions designated with the command.

As described above, at start-up of the execution of the application program, the application execution part 44 outputs the command designating the operating conditions corresponding to the application program to be executed to the system control part 41. After the process to reflect the operating conditions corresponding to the command is started in the system control part 41, a predetermined amount of processing time is required to complete the process. So, it takes a while for the application execution part 44 to complete the start of the application program and transit to the state in which the specified function is operable.

If the current setting of each part managed by the configuration part 42 matches the operating conditions designated with the command, the process to reflect the operating conditions corresponding to the command is not executed in the system control part 41. In this case, the time taken for the application execution part 44 to complete the start of the application program and transit to the state in which the specified function is operable is not required.

Therefore, when the specified function is selected by the user, the application management part 43 obtains the current setting managed by the configuration part 42. The application management part 43 also obtains the respective operating conditions corresponding to the plurality of application programs for allowing the specified function to operate based on the operating conditions management information 31. Based on the obtained information, the application management part 43 selects one of the application programs which takes the shortest amount of processing time required for the operating conditions reflection executed in the configuration part 42 with referring to the reference table 32. The application management part 43 then specifies the application program to execute to the application execution part 44.

As a result, the application execution part 44 is capable of reading and executing the application program which takes the shortest amount of start-up time among other plurality of application programs to operate the specified function.

With the information processing device 1, the user is caused to select single function from the multiple functions for the function selecting operation. Also, the user is caused to select the multiple functions simultaneously to make the multiple functions operate sequentially.

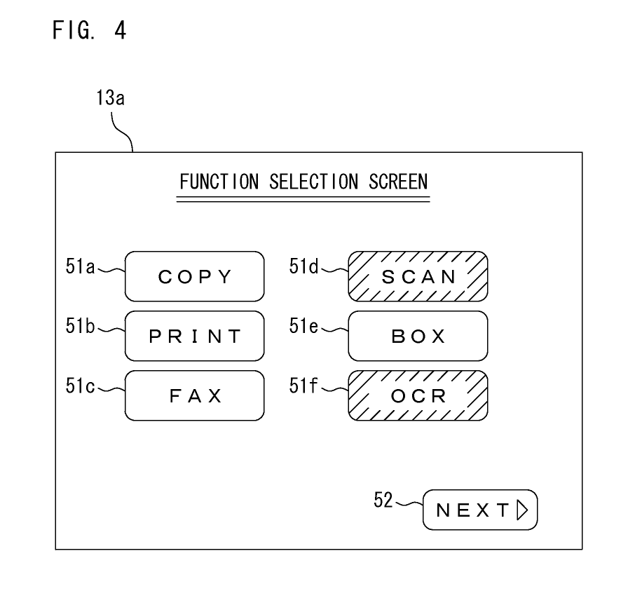

FIG. 4 shows an example of a function selection screen 13a displayed on the display unit 13 of the operational panel 12. The function selection screen 13a is an initial screen of the information processing device 1. Operation keys 51a to 51f corresponding to each of the multiple functions provided by the information processing device 1 are displayed on the function selection screen 13a. The user selects at least one of the plurality of operation keys 51a to 51f, thereby making a selection operation of a function.

In FIG. 4, two operation keys, the operation key 51d corresponding to the scan function and the operation key 51f corresponding to the OCR function, are shown to be selected. It is assumed that, for example, the user would like his or her document to be read with the scan function of the information processing device 1 and the read document to be converted to text with the OCR (optical character reader) function of the information processing device 1. In this case, the user makes an operation to select both of the operation key 51d corresponding to the scan function and the operation key 51f corresponding to the OCR function simultaneously as described above, thereby specifying the scan function and the OCR function to operate sequentially.

The operation sequence for allowing the multiple functions to operate sequentially in the information processing device 1 is specified by a manipulation sequence of the user to select the more than one operation key, for example. As described above, it is assumed that, for example, the user would like his or her document to be read with the scan function of the information processing device 1 and the read document to be converted to text with the OCR function of the information processing device 1. In this case, the user first makes an operation to the operation key 51d corresponding to the scan function, and next to the operation key 51f corresponding to the OCR function.

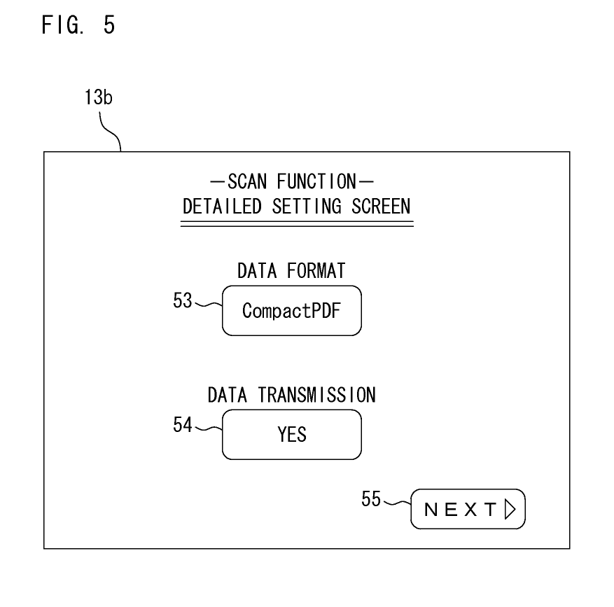

With the two functions, the scan function and the OCR function, selected as shown in FIG. 4, the user makes an operation to a NEXT key 52. The display screen of the display unit 13 then changes to a detailed setting screen relating to the scan function or the OCR function. FIG. 5 is an example of a detailed setting screen 13b relating to the scan function. The user is allowed to make own choice to specify the data format of the image data generated with the scan function or whether or not to transmit the image data generated with the scan function to the outside computer 2 or the server 3 with the detailed setting screen 13b. To be more specific, an operation key 53 for changing a setting relating to the data format of the image data generated with the scan function from a default and an operation key 54 for changing a setting relating to data transmission from a default are shown on the detailed setting screen 13b. In FIG. 5, the default relating to the data format is set as “CompactPDF,” and the default relating to the data transmission is set as “YES.” In order to change the default relating to the scan function shown on the detailed setting screen 13b, the user makes an operation to the operation key 53 and/or 54. So, the data format and/or the data transmission are set as desired. With an operation to a NEXT key 55 made by the user, the display screen of the display unit 13 changes to another detailed setting screen.

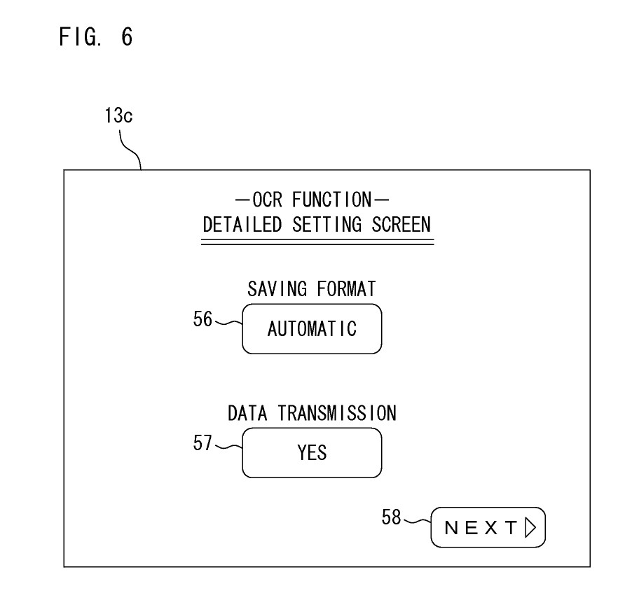

FIG. 6 is an example of a detailed setting screen 13c relating to the OCR function. The user is allowed to make own choice to specify the data format for saving the text data generated with the OCR function or whether or not to transmit the text data generated with the OCR function to the outside computer 2 or the server 3 with the detailed setting screen 13c. To be more specific, an operation key 56 for changing a setting relating to the saving format of the text data generated with the OCR function from a default and an operation key 57 for changing a setting relating to data transmission from a default are shown on the detailed setting screen 13c. In FIG. 6, the default relating to the saving format is set as “Automatic,” and the default relating to the data transmission is set as “YES.” In order to change the default relating to the OCR function shown on the detailed setting screen 13c, the user makes an operation to the operation key 56 and/or 57. So, the saving format and/or the data transmission are set as desired. With an operation to a NEXT key 58 by the user, the detailed setting is completed.

The information relating to the setting (hereafter, setting information) configured as described above is stored temporarily in the memory 11. The setting information is referred to as the operating conditions, in operation of the scan function and the OCR function, specified by the user.

After the detailed setting operation is made by the user as described above, the application management part 43 of the CPU 10 is put into operation, thereby starting a process to select the application program for allowing the function selected by the user to operate. The operating conditions are specified by the user by making the above-described detailed setting. The application management part 43 then excludes the application program that does not satisfy the operating conditions specified by the user from the subject of selection. The application management part 43 selects one application program which takes the shortest amount of processing time required for the operating conditions reflection executed in the configuration part 42 from at least one application program remained as the subject of selection.

When the user specifies more than one function to operate sequentially as described above, the application management part 43 excludes the application program that does not satisfy the operating conditions specified with the detailed setting screen 13b relating to the scan function from the plurality of first application programs PA1, PA2 and PA3 corresponding to the scan function, the first function. Similarly, the application management part 43 excludes the application program that does not satisfy the operating conditions specified with the detailed setting screen 13c relating to the OCR function from the plurality of second application programs PB1, PB2 and PB3 corresponding to the OCR function, the second function. The application management part 43 combines one of at least one first application program and one of at least one second application program, each of them remained as the subject of selection, thereby creating at least one pattern of combination (hereafter, combination pattern) capable of allowing the scan function and the OCR function to operate sequentially.

The application management part 43 determines the processing time required for the operating conditions reflection executed for allowing the scan function to operate based on each combination pattern. The application management part 43 also determines the processing time required for the operating conditions reflection executed for allowing the OCR function to operate after operation of the scan function based on each combination pattern. A combination of the first application program and the second application program is selected as the combination which takes the shortest amount of total processing time. Therefore, one of the first application programs for allowing the scan function to operate and one of the second application programs for allowing the scan function to operate are determined.

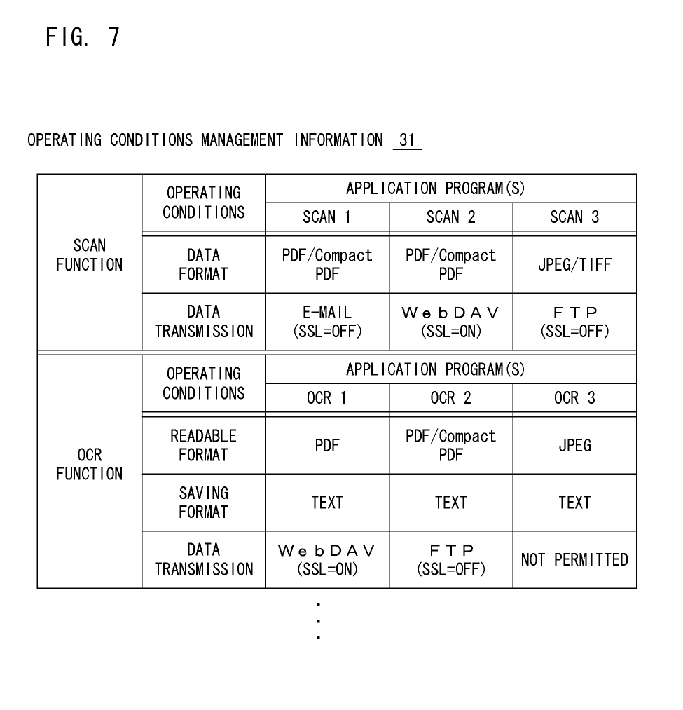

FIG. 7 shows an example of the operating conditions management information 31 managed by the application management part 43. The operating conditions management information 31 defines the respective operating conditions corresponding to the plurality of application programs for each of the functions realized by the information processing device 1.

By way of example, the plurality of application programs, “SCAN 1,” “SCAN 2” and “SCAN 3” are registered as for the scan function. In this case, a data format of the generated image data and a data transmission method are defined as the operating conditions of each of the plurality of application programs. The registered “SCAN 1,” “SCAN 2” and “SCAN 3” correspond to each of the plurality of the first application programs PA1, PA2 and PA3.

According to the defined operating conditions of the first application program PA1 corresponding to “SCAN 1,” the data format of the image data generated by reading the document is set as PDF or CompactPDF. For the data transmission method, transmission by E-mail is set, and SSL (secure socket layer) in data communication is not set. SSL is a communication protocol that encrypts data sent and received. A cryptographic communication is provided when SSL is set, and is not provided when SSL is not set.

According to the defined operating conditions of the first application program PA2 corresponding to “SCAN 2,” the data format is set as PDF or CompactPDF. For the data transmission method, transmission by WebDAV (web-based distributed authoring and versioning) is set, and SSL in data communication is set. WebDAV is a set of methods based on the communication protocol that performs data communication with the server 3 functions as the web server. WebDAV provides direct data communication with the server 3 without using other communication protocols such as FTP (file transfer protocol).

According to the defined operating conditions of the first application program PA3 corresponding to “SCAN 3,” the data format is set as JPEG or TIFF. For the data transmission method, transmission by FTP is set, and SSL in data communication is not set.

The plurality of application programs, “OCR 1,” “OCR 2” and “OCR 3” are registered as for the OCR function. In this case, data formats that are the readable format and the saving format and a data transmission method are defined as the respective operating conditions of the plurality of application programs. The registered “OCR 1,” “OCR 2” and “OCR 3” correspond to each of the plurality of the second application programs PB1, PB2 and PB3.

According to the defined operating conditions of the second application program PB 1 corresponding to “OCR 1,” the data format readable in data extraction is set as PDF, and the saving format is set as TEXT. For the data transmission method, transmission by WebDAV is set, and SSL in data communication is set.

According to the defined operating conditions of the second application program PB2 corresponding to “OCR 2,” the readable data format is set as PDF or CompactPDF, and the saving format is set as TEXT. For the data transmission method, transmission by FTP is set, and SSL in data communication is not set.

According to the defined operating conditions of the second application program PB3 corresponding to “OCR 3,” the readable data format is set as JPEG, and the saving format is set as TEXT. For the data transmission method, any data transmission is not permitted. The second application program PB3 is not allowed to transmit data to outside through the network 4.

The operating conditions management information 31 is registered by the application management part 43 at, for example, installation of the application program on the information processing device 1.

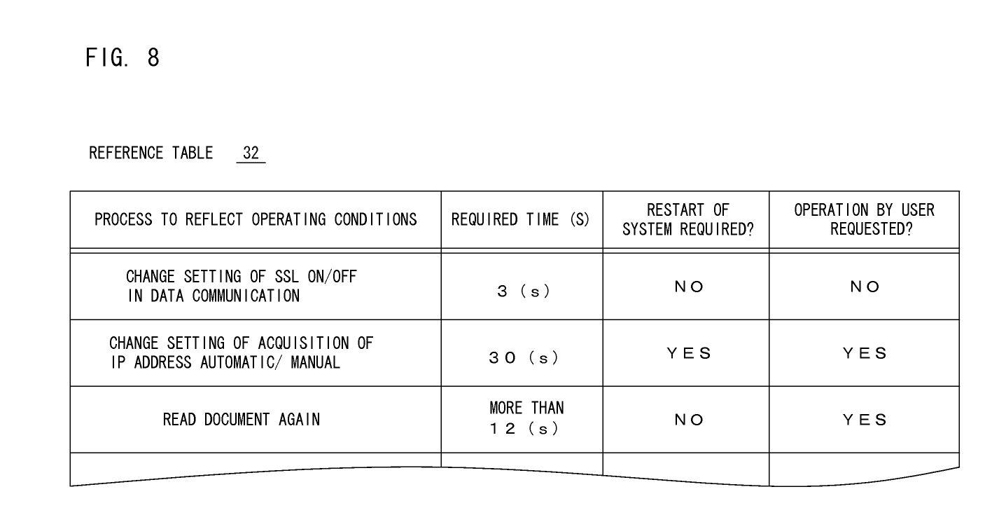

FIG. 8 shows an example of the reference table 32 referred to by the application management part 43. The reference table 32 includes, corresponding to the process executed to reflect the operating conditions of the application program, the processing time taken for the process, the information whether or not the process requires restart of the system and the information whether or not the process requires operations by the user. The restart of the system is to reboot the system program 21.

As some processes executed to reflect the operating conditions of the application program, predetermined processes of changing the setting of SSL in data communication, of changing the setting relating to acquisition of IP address whether to perform automatically or by a manual operation and of reading again the document are stated in the reference table 32 as shown in FIG. 8. The processes are only an example and other processes may also be stated in the reference table 32.

The configuration part 42 changes whether or not to set SSL in data communication at start-up of the application program if necessary. The processing time required for change of the setting of SSL is defined as 3 seconds in the reference table 32. It is not necessary for the system to restart or the user to make an operation to change the setting of SSL.

The configuration part 42 changes the setting relating to acquisition of IP address whether to perform automatically or by a manual operation at start-up of the application program if necessary. The processing time required for change of the setting relating to acquisition of IP address whether to perform automatically or by a manual operation is defined as 30 seconds in the reference table 32. In order to change the setting, restart of the system is required. That is why the amount of processing time is taken relatively long. Also, when the setting is changed from automatic acquisition of IP address to acquisition of IP address by a manual operation, the user is required to set the IP address by a manual operation.

The process of reading again the document is executed prior to start of the application program corresponding to the OCR function or completion of the start unless the data format generated with the scan function and the readable format with the OCR function are matched when the scan function and the OCR function operate sequentially as described above. Based on the reference table 32, more than 12 seconds taken to execute the process of reading again the document is defined. The processing time differs depending on a volume of the document for the process of reading again the document. The amount of time taken to read again the document with at least one page is defined as the processing time in the reference table 32. The process of reading again the document requires no restart of the system, but requires an operation by the user. The user needs to place the document again on the scanner unit 15.

The application management part 43 selects the application program allowing the function selected by the user to operate with referring to the above-described operating conditions management information 31 and reference table 32. As a result, the application program that takes the shortest amount of processing time required for the operating conditions reflection is selected. The detail is described below.

The operation of the information processing device 1 when the user specifies the scan function and the OCR function to operate sequentially as described above is explained. The data format is set as CompactPDF by the user as operating conditions of the scan function as shown in FIG. 5, for example. In this case, the application management part 43 refers to the operating conditions management information 31, thereby excluding the particular application program from the subject of selection. The particular application program is that the one for which the operating conditions not setting data format as CompactPDF are defined. In the example of the operating conditions management information 31 shown in FIG. 7, the first application program PA3 corresponding to “SCAN 3” is excluded from the subject of selection. There is no application program excluded from the subject of selection in the example of the operating conditions management information 31 shown in FIG. 7 since every application program is permitted to execute data transmission as for the scan function.

As shown in FIG. 6, no particular saving format is specified by the user when the saving format is set so as to specify automatically as the operating conditions of the OCR function by the user. So, no application program is excluded from the subject of selection. The user specifies to make data transmission on the example of the screen of FIG. 6. So, the application program not permitted to execute data transmission is excluded from the subject of selection. In the example of the operating conditions management information 31 shown in FIG. 7, the second application program PB3 corresponding to “OCR 3” is not permitted data transmission, and is excluded from the subject of selection.

The application program that does not satisfy the operating conditions specified by the user is excluded as described above. As a result, the first application programs PA1 and PA2 corresponding to “SCAN 1” and “SCAN 2” are remained for the scan function, and the second application programs PB1 and PB2 corresponding to “OCR 1” and “OCR 2” are remained for the OCR function. At least one pattern of a combination of application programs, the subject of selection, is created. The four patters (1) “SCAN 1” and “OCR 1,” (2) “SCAN 1” and “OCR 2,” (3) “SCAN 2” and “OCR 1,” and (4) “SCAN 2” and “OCR 2” are thereby created.

The application management part 43 calculates the total amount of processing time required for the operating conditions reflection based on each of the above-described four patterns of the combination. The application management part 43 obtains the current setting from the configuration part 42, and refers to the current setting and the respective operating conditions of the application programs. The application management part 43 calculates the total amount of processing time required for the process to reflect the operating conditions executed at the start-up of the application program that satisfies the operating conditions specified by the user and included in each pattern.

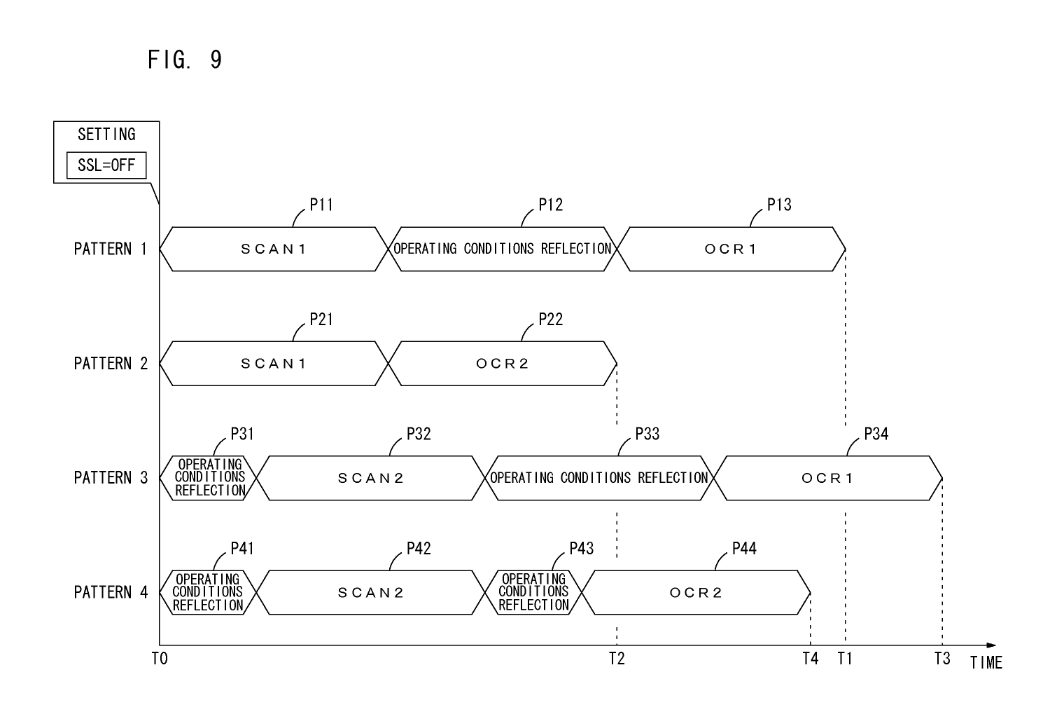

FIG. 9 conceptually shows the process with each of the four patters of the combination (hereafter, combination pattern) allowing the scan function and the OCR function to operate sequentially. In FIG. 9, the current setting configured by the configuration part 42 shows that SSL in data communication is not set.

Firstly, with the combination pattern 1, the first application program PA1 corresponding to “SCAN 1” and the second application program PB 1 corresponding to “OCR 1” are executed in series. The operating conditions management information 31 of FIG. 7 shows that SSL in data communication is set for the operating conditions of the first application program PA1 corresponding to “SCAN 1.” So, the current setting may be applied as it is. The first application program PA1 corresponding to “SCAN 1” is immediately started without execution of the process to reflect the operating conditions at the start-up of the first application program PA1 corresponding to “SCAN 1.” In response to the start, the scan function operates (process P11). With the scan function, image data in CompactPDF specified as operating conditions by the user is generated.

With reference to the operating conditions management information 31 of FIG. 7, the readable data format is set as only “PDF” for the operating conditions of the second application program PB 1 corresponding to “OCR 1.” SSL in data communication is set. With the combination pattern 1, after execution of the first application program PA1 corresponding to “SCAN 1,” the process to reflect the operating conditions of the second application program PB 1 corresponding to “OCR 1” is executed at start-up of the second application program PB1 (process P12). SSL in data communication is changed not to set, and the document is read again to generate image data in the readable format, “PDF.” According to the reference table 32 of FIG. 8, more than 15 seconds are required for the process.

With the combination pattern 1, the OCR function operates by the start-up of the second application program PB1 after execution of the process to reflect the operating conditions of the second application program PB1 (process P13). By way of example, the process is started at time T0, and all processes are completed at time T1 with the combination pattern 1.

Secondly, with the combination pattern 2, the first application program PA1 corresponding to “SCAN 1” and the second application program PB2 corresponding to “OCR 2” are executed in series. SSL in data communication is not set for the operating conditions of the first application program PA1 corresponding to “SCAN 1”. So, the current setting may be applied as it is. The first application program PA1 corresponding to “SCAN 1” is immediately started without execution of the process to reflect the operating conditions at the start-up of the first application program PA1 corresponding to “SCAN 1.” In response to the start, the scan function operates (process P21). With the scan function, image data in CompactPDF specified as operating conditions by the user is generated.

According to the operating conditions management information 31 of FIG. 7, the readable data format is set as “PDF or CompactPDF” for the operating conditions of the second application program PB2 corresponding to “OCR 2.” The character extraction may be executed with the image data as it is generated with the scan function. SSL in data communication is not set. With the combination pattern 2, after execution of the first application program PA1 corresponding to “SCAN 1,” the process to reflect the operating conditions of the second application program PB2 corresponding to “OCR 2” is not required at start-up of the second application program PB2. So, the OCR function operates immediately after operation of the scan function (process P22). By way of example, the process is started at time T0, and all processes are completed at time T2 with the combination pattern 2.

Thirdly, with the combination pattern 3, the first application program PA2 corresponding to “SCAN 2” and the second application program PB 1 corresponding to “OCR 1” are executed in series. The operating conditions management information 31 of FIG. 7 shows that SSL in data communication is set for the operating conditions of the first application program PA2 corresponding to “SCAN 2.” So, the current setting may not be applied as it is, and the configuration part 42 changes the setting. The process to reflect the operating conditions of the first application program PA2 corresponding to “SCAN 2” is executed at the start-up (process P31). Based on the reference table 32, the process requires 3 seconds. In response to the completion of the operating conditions reflection, the first application program PA2 corresponding to “SCAN 2” is started, and the scan function operates (process P32). With the scan function, image data in CompactPDF specified as operating conditions by the user is generated.

The readable data format is set as only “PDF” for the operating conditions of the second application program PB1 corresponding to “OCR 1.” SSL in data communication is set. With the combination pattern 3, after execution of the first application program PA2 corresponding to “SCAN 2,” the process to reflect the operating conditions of the second application program PB 1 corresponding to “OCR 1” is executed at start-up of the second application program PB1 (process P33). The document is read again to generate image data in readable “PDF.” According to the reference table 32, more than 12 seconds are required for the process.

With the combination pattern 3, the OCR function operates by the start-up of the second application program PB1 after execution of the process to reflect the operating conditions of the second application program PB 1 (process P34). By way of example, the process is started at time T0, and all processes are completed at time T3 with the combination pattern 3.

Finally, with the combination pattern 4, the first application program PA2 corresponding to “SCAN 2” and the second application program PB2 corresponding to “OCR 2” are executed in series. SSL in data communication is set for the operating conditions of the first application program PA2 corresponding to “SCAN 2.” So, the current setting may not be applied as it is, and the configuration part 42 changes the setting. The process to reflect the operating conditions of the first application program PA2 corresponding to “SCAN 2” is executed at the start-up (process P41). Based on the reference table 32, the process requires 3 seconds. In response to the completion of the operating conditions reflection, the first application program PA2 corresponding to “SCAN 2” is started, and the scan function operates (process P42). With the scan function, image data in CompactPDF specified as the operating conditions by the user is generated.

The readable data format is set as “PDF or CompactPDF” for the operating conditions of the second application program PB2 corresponding to “OCR 2.” The character extraction may be executed with the image data as it is generated with the scan function. SSL in data communication is not set. The configuration part 42 needs to change to set SSL to execute the second application program PB2 corresponding to “OCR 2” after execution of the first application program PA1 corresponding to “SCAN 1.” The process to reflect the operating conditions of the second application program PB2 corresponding to “OCR 2” is executed at start-up of the second application program PB2 (process P43). According to the reference table 32, 3 seconds are required for the process. In response to the completion of the operating conditions reflection, the second application program PB2 corresponding to “OCR 2” is started, and the OCR function operates (process P44). By way of example, the process is started at time T0, and all processes are completed at time T4 with the combination pattern 4.

When more than one combination pattern is obtained, the application management part 43 selects one combination pattern which takes the shortest amount of total processing time require for the operating conditions reflection from the obtained combination patterns as described above. In the example of FIG. 9, the combination pattern 2 is selected. In the example of FIG. 9, it assumes that the same amount of time for the scan function to operate (processes P11, P21, P32 and P42) with each of the four combination patterns is required, and the same amount of time for the OCR function to operate (processes P13, P22, P34 and P44) with each of the four combination patterns is required.

The application execution part 44 reads and executes the application programs of the combination pattern selected by the application management part 43, sequentially. More specifically, the application execution part 44 reads and executes the first application program PA1 corresponding to “SCAN 1” stored in the storage device 19 when the combination pattern 2 shown in FIG. 9 is selected. After the execution, the application execution part 44 then reads and executes the second application program PB2 corresponding to “OCR 2.” As a result, in operation of each function, the user has to wait for a shorter amount of time. Also, time to complete all processes may be shortened. The processes may be executed more efficiently in the information processing device 1.

In selection of the combination pattern which takes the shortest amount of total processing time required for the operating conditions reflection by the application management part 43, sometimes, more than one combination pattern takes the shortest amount of total processing time. In such a case, the combination pattern that requires the operating conditions reflection accompanying the restart of the system or the one requesting the user to make an operation is excluded by the application management part 43. The above-described operating conditions reflection extremely lowers the convenience and the operability of the information processing device 1. The execution of such process at start-up of the application program is prevented.

There is sometimes still more than one combination pattern remained after exclusion of the above-described combination pattern. In this case, the user is allowed to select one combination pattern with an application selection screen displayed on the display unit 13 of the operational panel 12 by the application management part 43.

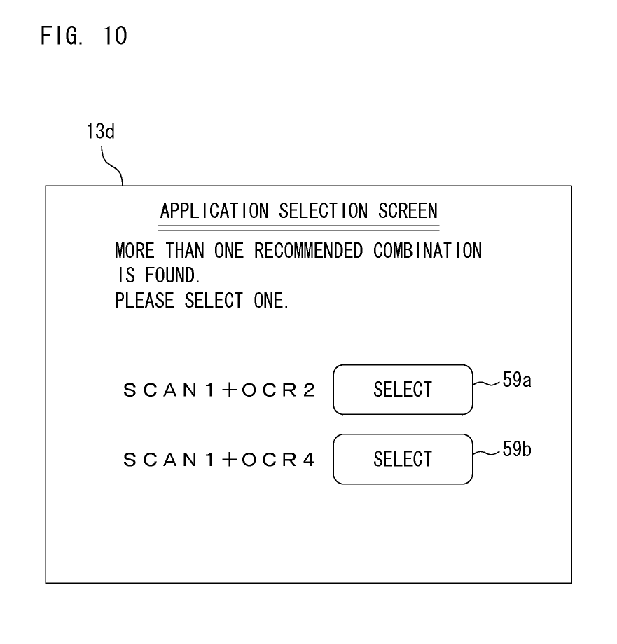

FIG. 10 shows an example of an application selection screen 13d. As more than one combination pattern is finally extracted by the application management part 43, the extracted combination patterns are shown on the application selection screen 13d. FIG. 10 shows the example that two combination patterns are extracted. Operation keys 59a and 59b operable for the user to select are shown corresponding to each combination pattern. The user operates one of the operation keys, thereby selecting the desired combination pattern.

Next, an example when the user specifies to operate only the scan function alone is explained. The user sets the data format as CompactPDF and the data transmission to execute as the operating conditions of the scan function as shown in FIG. 5, for example. In this case, the application management part 43 refers to the operating conditions management information 31, thereby excluding the first application program PA3 corresponding to “SCAN 3” from the subject of selection.

The application program that does not satisfy the operating conditions specified by the user is excluded as described above. As a result, the first application programs PA1 and PA2 corresponding to “SCAN 1” and “SCAN 2” are remained for the scan function. The application management part 43 calculates the total amount of processing time required for the operating conditions reflection based on each of the first application programs PA1 and PA2. The application management part 43 obtains the current setting from the configuration part 42, and refers to the current setting and the operating conditions of each application program. The application management part 43 calculates the amount of processing time required for the process to reflect the operating conditions executed at start-up of each application program that satisfies the operating conditions specified by the user.

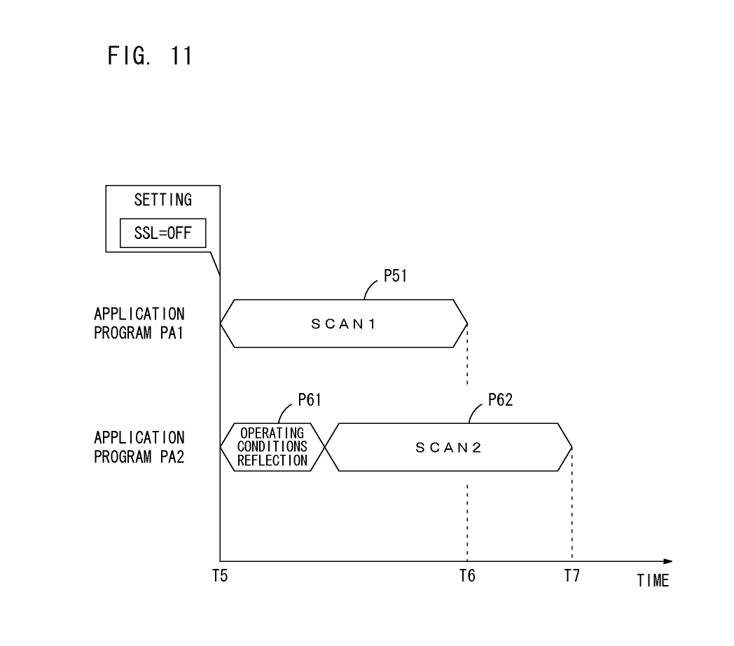

FIG. 11 conceptually shows the respective processes executed by the plurality of first application programs PA1 and PA2. In FIG. 11, the current setting configured by the configuration part 42 shows that SSL in data communication is not set.

Firstly, the first application program PA1 corresponding to “SCAN 1” is executed. The operating conditions management information 31 of FIG. 7 shows that SSL in data communication is set for the operating conditions of the first application program PA1 corresponding to “SCAN 1.” So, the current setting may be applied as it is. The first application program PA1 corresponding to “SCAN 1” is immediately started without execution of the process to reflect the operating conditions at the start-up of the application program PA1. In response to the start, the scan function operates (process P51). With the scan function, image data in CompactPDF specified as the operating conditions by the user is generated. By way of example, the process is started at time T5, and all processes are completed at time T6.

Secondly, the first application program PA2 corresponding to “SCAN 2” is executed. The operating conditions management information 31 of FIG. 7 shows that SSL in data communication is set for the operating conditions of the first application program PA2 corresponding to “SCAN 2.” So, the current setting may not be applied as it is, and the configuration part 42 changes the setting. The process to reflect the operating conditions of the first application program PA2 corresponding to “SCAN 2” is executed at the start-up (process P61). Based on the reference table 32, the process requires 3 seconds. In response to the completion of the operating conditions reflection, the first application program PA2 corresponding to “SCAN 2” is started, and the scan function operates (process P62). With the scan function, image data in CompactPDF specified as the operating conditions by the user is generated. By way of example, the process is started at time T5, and all processes are completed at time T7.

As described above, there is more than one application program allowing the single function selected by the user to operate. The application management part 43 excludes the application program that does not satisfy the operating conditions specified by the user from the subject of the selection, thereby selecting the application program that takes the shortest amount of total processing time required for the process to reflect the operating conditions from the remaining subject of selection. In the example of FIG. 11, the first application program PA1 is selected.

The application execution part 44 reads and executes the application program selected by the application management part 43. As the first application program PA1 shown in FIG. 11 is selected, the application execution part 44 reads and executes the first application program PA1 corresponding to “SCAN 1” stored in the storage device 19. As a result, in operation of the scan function, the user has to wait for a shorter amount of time. Also, the amount of time to complete all processes with the scan function may be shortened. The processes may be executed more efficiently in the information processing device 1.

When the application management part 43 selects the application program allowing the single function selected by the user to operate, sometimes, the number of the application program takes the shortest amount of processing time required for the process to reflect the operating conditions is more than one. In such a case, the same process as the one executed in the example of the above-described combination pattern is executed.

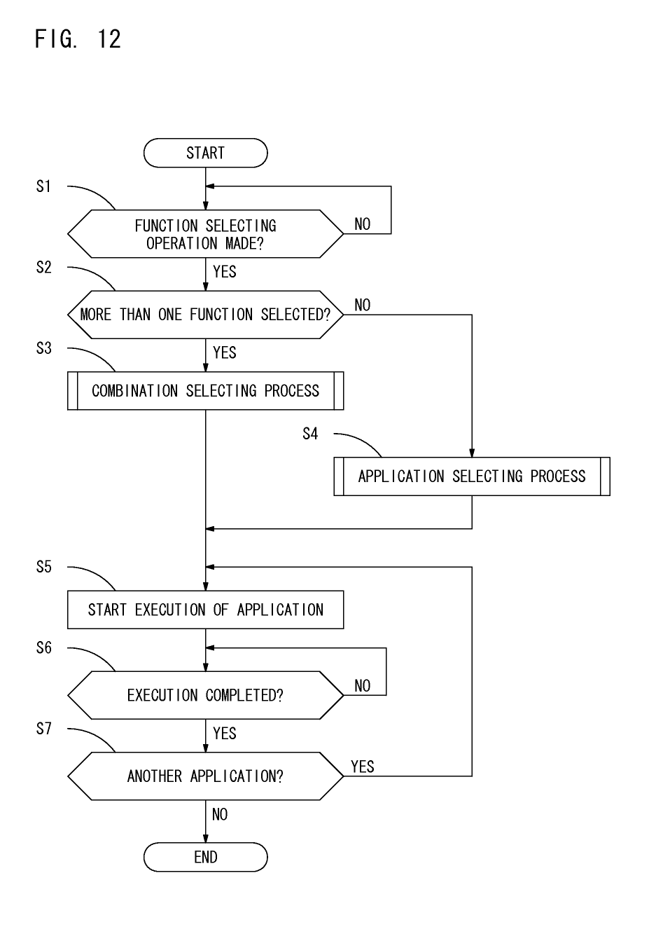

The detail of the process sequence of selecting and executing the application program corresponding to the function selected by the user in the information processing device 1 is described next. FIGS. 12 to 17 are flow diagrams explaining the process sequence of the process executed by the CPU 10 of the information processing device 1. The process is started mainly by execution of the application management program 22 by the CPU 10.

As shown in FIG. 12, in response to the start of the process, the CPU 10 is put into operation to function as the application management part 43, and is put into a waiting state until the function selecting operation is made by the user (step S1). When the function selecting operation is made by the user, the CPU 10 determines whether or not more than one function is selected (step S2). If more than one function is selected, the CPU 10 executes a process to select a combination (hereafter, combination selecting process) (step S3). The combination selecting process selects one combination pattern of the application programs allowing each function to operate based on the operation sequence of the more than one function selected by the user. If the single function is selected, a process to select an application (hereafter, application selecting process) is executed (step S4). The application selecting process selects one application program allowing the function to operate based on the single function selected by the user.

The CPU 10 puts the application execution part 44 into operation to function, and starts execution of the application program selected in step S3 or S4 (step S5). The application program which takes the short amount of start-up time has been selected in step S3 or S4. The CPU 10 immediately starts the application program and allows the function selected by the user to operate. As completing the execution of the application program (when a result of step S6 is YES), the CPU 10 determines whether or not there is still any other application program to be executed (step S7). If there is any, the CPU 10 returns to the process in step S5, and executes the application program to be executed next. If there is no other application program to be executed, the process is completed.

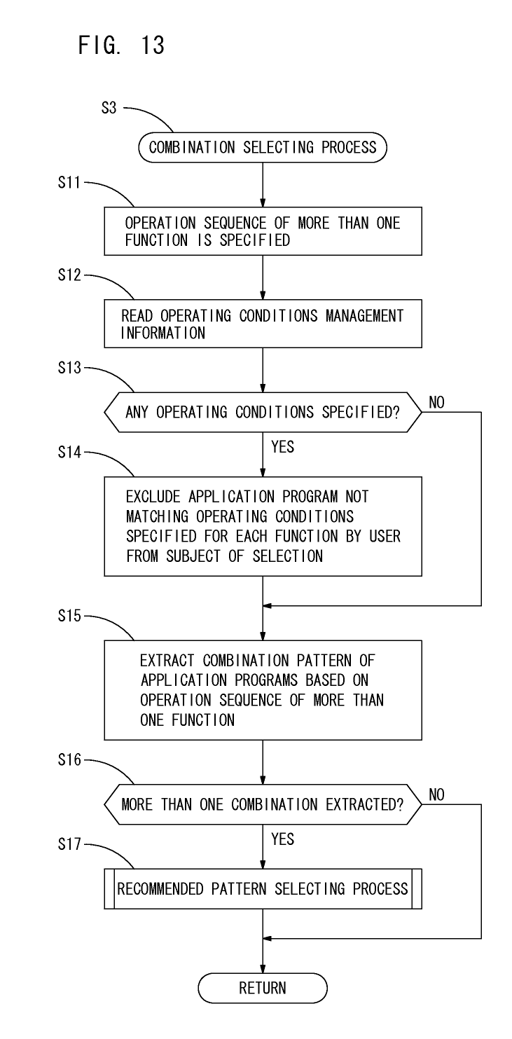

FIG. 13 is a flow diagram explaining in detail an exemplary process sequence of the combination selecting process (step S3). After starting the process, the CPU 10 specifies the operation sequence of the more than one function selected by the user (step S11). By way of example, the first function selected by the user is specified as the function operates at first, and the second function selected by the user is specified as the function operates at second. The same operation to specify is executed for the third or more functions selected by the user. The operation sequence is specified corresponding to the order of selection of at least one function made by the user. The CPU 10 reads the operating conditions management information 31 stored in the storage device 19 (step S12).

The CPU 10 determines whether or not the operating conditions are specified by the user (step S13). When the operating conditions are specified by the user (when a result of step S13 is YES), the CPU 10 excludes, base on the operating conditions of the application program corresponds to each function, the application program which does not match the operating conditions specified for each function by the user from the subject of the selection (step S14).

The CPU 10 extracts, based on the operation sequence of the more than one function, the combination pattern of the application programs allowing the more than one function to operate (step S15). The CPU 10 determines whether or not more than one combination pattern is extracted (step S16). As more than one combination pattern is extracted, a process to select a recommended pattern (hereafter, recommended pattern selecting process) to select a recommended pattern from the more than one combination pattern is executed (step S17). As only one combination pattern is extracted in step S15, the process in step S17 is not executed, and the combination selecting process is completed.

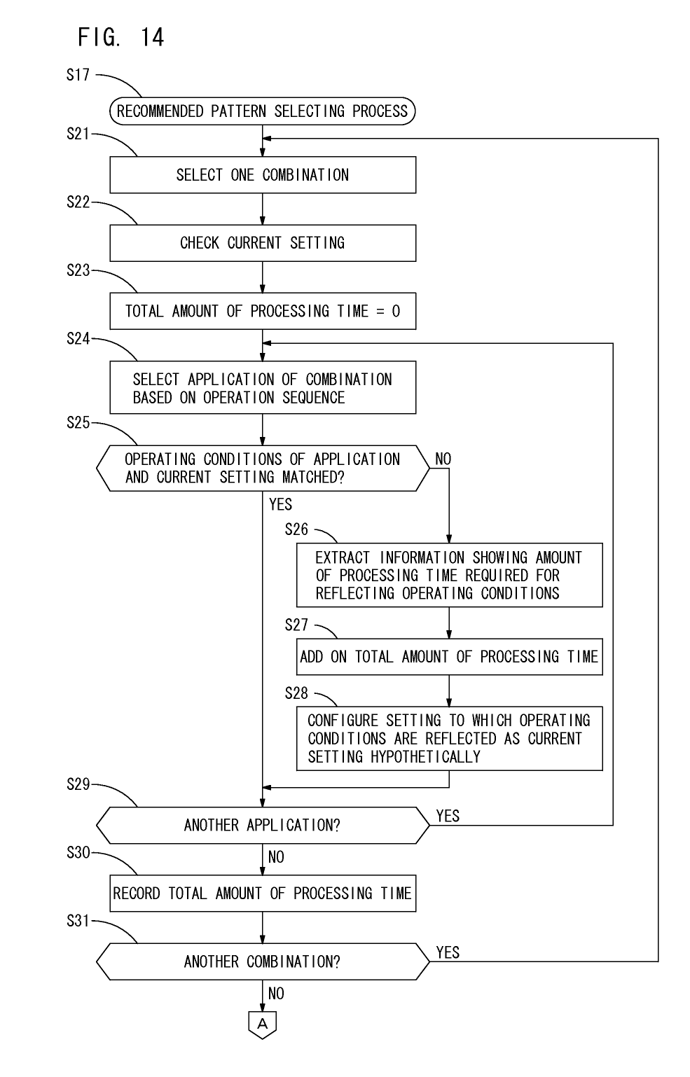

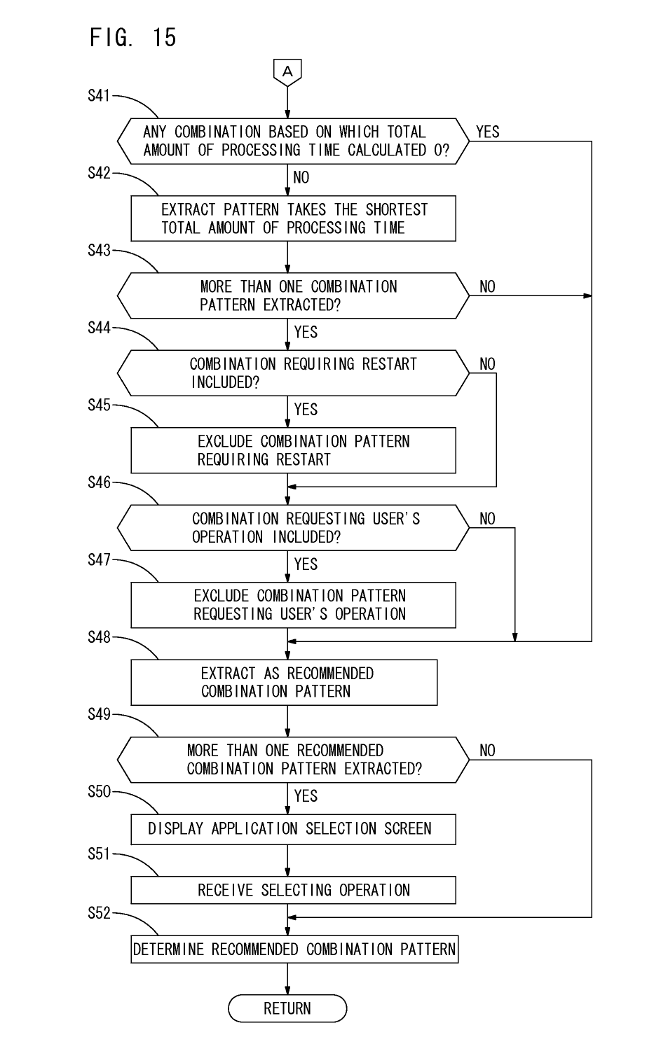

FIGS. 14 and 15 are flow diagrams explaining in detail an exemplary process sequence of the recommended pattern selecting process (step S17). In response to start of the process, the CPU 10 selects one combination pattern from the more than one extracted combination pattern (step S21). The CPU 10 checks the current setting configured by the configuration part 42 (step S22), and assigns 0 to the total amount of the processing time (step S23).

The CPU 10 selects one of the application programs of the combination pattern based on the operation sequence (step S24). The CPU 10 then determines whether or not the operating conditions of the selected application program match the current setting (step S25). If the operating conditions of the application program do not match (when a result of step S25 is NO), the CPU 10 extracts the information showing the amount of the processing time required to reflect the operating conditions from the reference table 32 (step S26). The amount of the processing time shown by the extracted information is added on the total amount of the processing time (step S27). The setting to which the operating conditions are reflected is configured as the current setting hypothetically (step S28). If the operating conditions of the application program match the current setting (when a result of step S25 is YES), the process in steps S26, S27 and S28 are not executed.

The CPU 10 determines if there is any other application program consists of the combination pattern (step S29). If there is, the CPU 10 returns to the process in step S24 to execute the above-described process repeatedly. In step S25, the CPU 10 determines whether or not the operating conditions match the hypothetical current setting configured in step S28. The process in steps S24 to S29 is executed based on each application program of the combination pattern. So, the amount of the processing time required to reflect the operating conditions of each application program is added on the total amount.

After executing the above-described process based on every application program of the combination pattern, the CPU 10 records the total amount of the processing time required for reflecting the operating conditions temporarily on the memory 11 (step S30). The CPU 10 determines whether or not there still is another combination pattern (step S31). If there is another combination pattern, the CPU 10 returns to the process in step S21 to execute the same process as described above. If there is no other combination pattern, the CPU 10 proceeds with the process in the flow diagram of FIG. 15.

In the flow diagram of FIG. 15, the CPU 10 first determines whether or not there is any combination pattern based on which the total amount of the processing time is calculated 0 (step S41). When there is the combination pattern based on which the total amount of the processing time is calculated 0 (when a result of step S41 is YES), the CPU 10 moves on to step S48. When there is no combination pattern based on which the total amount of the processing time is calculated 0 (when a result of step S41 is NO), the CPU 10 extracts the combination pattern based on which the total amount of the processing time calculated is the smallest amount (step S42). Whether or not more than one combination pattern is extracted is then determined (step S43). Only one combination pattern is extracted unless more than one combination pattern is extracted here. So, the CPU 10 proceeds with the process in step S48. When more than one combination pattern is extracted (when a result of step S43 is YES), the CPU 10 determines whether or not the operating conditions reflection requiring restart of the system is executed with any of the extracted more than one combination pattern (step S44). If the combination pattern requiring the restart of the system is included in the extracted combination patterns, the combination pattern is excluded (step S45). If the combination pattern requiring the restart of the system is not included, the process in step S45 is not executed. The CPU 10 then determines whether or not the operating conditions reflection requesting the user to make the operation is executed with any of the extracted more than one combination pattern (step S46). If the combination pattern requesting the user to make the operation is included in the extracted combination patterns, the combination pattern is excluded (step S47). If the combination pattern requesting the user to make the operation is not included, the process in step S47 is not executed.

The CPU 10 extracts the combination pattern obtained as the result of the above-described process as a recommended combination pattern (step S48). The CPU 10 determines whether or not more than one recommended combination pattern is extracted (step S49). In response to the extraction of one or more combination pattern, the application selection screen is displayed on the display unit 13 (step S50). The function selecting operation made by the user is received (step S51). One of the recommended combination patterns selected by the user is determined (step S52). If one recommended combination pattern has already been extracted in step S49 (when a result of step S49 is NO), the CPU 10 determines the recommended combination pattern (step S52).

Through the above-described process, one combination of the application programs takes the shortest amount of processing time required for the operating conditions reflection when the more than one function selected by the user is allowed to operate sequentially. The application execution part 44 executes each application program of the selected combination, sequentially. The amount of the start time of each application program gets shorter. The user is allowed to use the information processing device 1 efficiently.

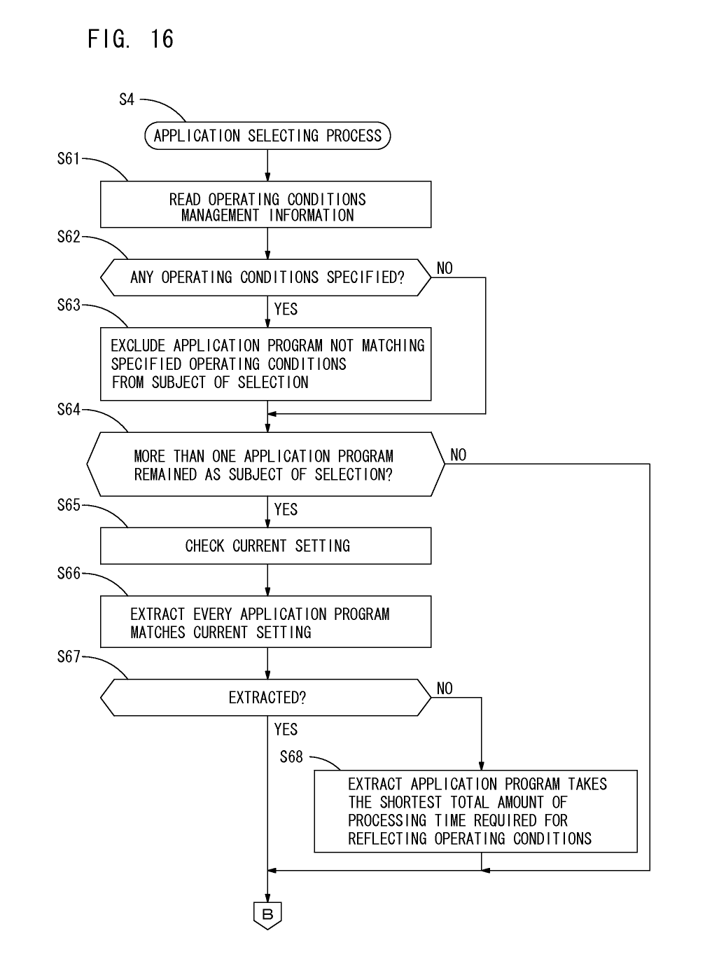

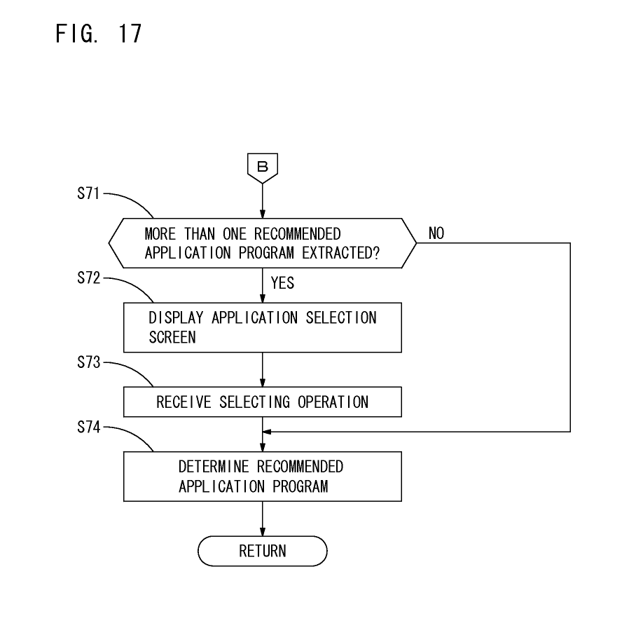

FIGS. 16 and 17 are flow diagrams explaining in detail an exemplary process sequence of the application selecting process (step S4). In response to start of the process, the CPU 10 reads the operating conditions management information 31 stored in the storage device 19 (step S61). The CPU 10 determines whether or not the operating conditions are specified by the user (step S62). As the operating conditions are specified by the user (when a result of step S62 is YES), the application program that does not satisfy the operating conditions specified by the user is excluded, based on the respective operating conditions of the application programs corresponding to one function selected by the user, from the subject of the selection (step S63). As the operating conditions are not specified by the user, the process in step S63 is not executed. The CPU 10 determines whether or not more than one application program is remaining as the subject of the selection (step S64).

When more than one application program is remaining as the subject of the selection (when a result of step S64 is YES), the CPU 10 checks the current setting configured by the configuration part 42 (step S65). Every application program of which the operating conditions match the current setting is extracted from more than one application program (step S66). The application program capable of being executed without the operating conditions reflection may be extracted. However, the application program is not always extracted as a result of the extraction process in step S66. So, the CPU 10 determines whether or not at least one application program is extracted through the process in step S66 (step S67). If no application program is extracted (when a result of step S67 is NO), the CPU 10 refers to the operating conditions management information 31 and the reference table 32 based on the current setting, thereby extracting the application program which takes the shortest amount of the processing time required for reflecting the operating conditions from more than one application program (step S68). The application program thereby extracted in step S66 or S68 is specified as the recommended application program.

When only one application program is remaining as the subject of the selection in step S64 (when a result of step S64 is NO), the process in steps S65 to S68 as described above is not executed. The one application program is specified as the recommended application program. The CPU 10 proceeds with the process in FIG. 17.

In the flow diagram shown in FIG. 17, the CPU 10 determines whether or not more than one recommended application program is extracted (step S71). As more than one recommended application program is extracted, the application selection screen is displayed on the display unit 13 (step S72), and the selecting operation by the user is received (step S73). The one recommended application program selected by the user is determined as the program to be executed (step S74). As the one recommended application program has already been extracted in step S71 (when a result of step S71 is NO), the CPU 10 determines the recommended application program as the program to be executed (step S74).

The one application program takes the shortest amount of processing time required for the operating conditions reflection is selected with the above-described process when the specified function selected by the user is allowed to operate. The application execution part 44 executes the selected application program. The application program is started in a shorter amount of time. So, the specified function selected by the user may operate immediately. The user is allowed to use the information processing device 1 efficiently.

The application program allowing each function to operate is capable of being installed on the information processing device 1 of the present preferred embodiment as described above. Each function is such as the copy function, the print function, the scan function, the fax function, the box function and the OCR function. The application program installed on the information processing device 1 is stored in the storage device 19. Sometimes, the plurality of application programs is installed for one function. In such a case, the operating conditions of each application program differ from each other. The processes unique to the respective operating conditions are executed by means of each application program.

In the information processing device 1, the application management part 43 manages the respective operating conditions of the plurality of application programs. As the single function is selected by the user, the application management part 43 selects one from the plurality of application programs. The application management part 43 obtains the current setting configured by the configuration part 42, and selects, based on the operating conditions of each application program corresponding to the selected function, one application program which takes the shortest amount of processing time required for reflecting the operating conditions executed in the configuration part 42. The application execution part 44 executes the one application program selected by the application management part 43. In response to the execution, the function selected by the user operates in the information processing device 1.

In the present preferred embodiment, the plurality of application programs allowing the specified function to operate are installed. Even when the operating conditions of each application program are not clear to the user, the application program takes the shortest amount of start-up time for start of the application program is selected automatically. As a result, the user needs to wait for a shorter amount of time, and better convenience and operability are achieved.

According to the present preferred embodiment, the application management part 43 selects one application program. At the time, if the operating conditions are specified by the user, the application program which takes the shortest amount of processing time required for reflecting the operating conditions from at least one application program each of which satisfies the specified operating conditions. So, the operating conditions specified by the user may be reflected. At the same time, the user needs to wait for a shorter amount of time.

The application management part 43 selects the application program capable of being executed in preference without change of the current setting configured by the configuration part 42. Therefore, the amount of time making the user wait may be shortened as much as possible.

Moreover, as described above, the information processing device 1 of the present preferred embodiment allows the first function and the second function to operate sequentially, thereby being capable of executing a series of processes. In this case, the application management part 43 obtains the current setting configured by the configuration part 42. The application management part 43 then selects one combination of the first application program and the second application program which takes the shortest amount of total time of processing time required for the operating conditions reflection executed in the configuration part 42 in operation of the first function and processing time required for the operating conditions reflection executed in the configuration part 42 in operation of the second function. Based on the operating conditions of each of the first application program allowing the first function to operate and the second application program allowing the second function to operate, the selection is made. The process of selection is the same for allowing more than two functions to operate sequentially.

The entire operating conditions reflection which is minimum is executed at time of starting the application program corresponding to each function in sequential operation of the more than one function. The more than one function operates nondisruptively in series even when the user does not know the respective operating conditions of the application programs. As a result, the user no longer needs to wait for a long time in operation of each function. Also, the processing time required until the completion of operation of all functions is shortened. The execution of the job is realized efficiently.

The specified function is allowed to operate while the plurality of application programs allowing the specified function to operate are installed. In such a case, as described above, the application program which takes the shortest processing time required for the operating conditions reflection is automatically selected based on the respective operating conditions of the plurality of application programs. The amount of the processing time required for the operating conditions reflection executed at start-up of the application program is shortened even when the user does not know the operating conditions of each application program. The user needs to wait for a shorter time, and the convenience and the operability improve.

As described above, even when a series of processes are executed by allowing the first function and the second function to operate sequentially, the time the user needs to wait is shortened and the better convenience and operability are achieved.

### (Modifications)

While the present preferred embodiment of the present invention has been described above, the present invention is not limited to the present preferred embodiment. Various modifications may be applied to the present invention.

In the present preferred embodiment described above, the scan function and the OCR function are selected as an example of allowing more than one function to operate sequentially in the information processing device 1. The functions are not limited to the scan function and the OCR function. Even in a case that a combination of functions other than the scan function and the OCR function is selected, the efficient process is enabled. To be more specific, when the user specifies to make the more than one function operate sequentially, the combination of the application programs which takes the shortest total processing time required for the operating conditions reflection is selected as described above. So, the user is not made to wait, and the process may be executed efficiently.

In the above-described present preferred embodiment, the information processing device 1 is shown to be a device with multiple functions such as an MFP. The device is not necessarily the device such as the MFP. To be more specific, the information processing device 1 may be a single function device such as a copier providing only the copy function, a scanner providing only the scan function and a printer providing only the print function.

Furthermore, in the present preferred embodiment described above, the operation corresponding to the OCR function is executed by execution of the process only in the information processing device 1. However, the information processing device 1 may work with the computer 2 or the server 3 through the network 4 and execute the process, thereby executing the operation corresponding to the OCR function. The operation executed through such cooperation may also be applied to other functions besides the OCR function.

What is claimed is:

1. An information processing device, comprising:
a storage part for storing a plurality of application programs allowing a specified function to operate under operating conditions differ among said plurality of application programs;
a configuration part for configuring a setting to reflect the operating conditions corresponding to one application program selected from said plurality of application programs;
an application management part for managing the respective operating conditions of said plurality of application programs, for obtaining a current setting configured by said configuration part when allowing said specified function to operate and for selecting, based on the respective operating conditions of said plurality of application programs, said one application program which takes the shortest amount of processing time required for an operating conditions reflection executed by said configuration part; and
an application execution part for allowing said specified function to operate with execution of said one application program selected by said application management part.

2. The information processing device according to claim 1, further comprising:
a manipulation part for receiving an operation to specify the operating conditions for said specified function made by a user, wherein
said application management part selects said one application program which takes the shortest amount of processing time required for the operating conditions reflection executed by said configuration part from at least one application program which satisfies the operating conditions specified by the user.

3. The information processing device according to claim 1, wherein
said application management part selects in preference the application program capable of being executed without change of the current setting configured by said configuration part.

4. The information processing device according to claim 3, wherein
when the number of the application program capable of being executed without change of the current setting configured by said configuration part is more than one, said application management part prompts the user to make an operation to select said one application program and selects said one application program specified by the user.

5. An information processing device executes a series of processes by allowing a first function and a second function to operate sequentially, comprising:
a storage part for storing a plurality of first application programs allowing said first function to operate under operating conditions differ among said plurality of first application programs and a plurality of second application programs allowing said second function to operate under operating conditions differ among said plurality of second application programs;
a configuration part for configuring a setting to reflect the operating conditions corresponding to one first application program selected from said plurality of first application programs for allowing said first function to operate and for configuring a setting to reflect the operating conditions corresponding to one second application program selected from said plurality of second application programs for allowing said second function to operate;
an application management part for managing the respective operating conditions of said plurality of first application programs and said plurality of second application programs, for obtaining in advance a current setting configured by said configuration part when allowing said first function and said second function to operate sequentially and for selecting, based on the respective operating conditions of said plurality of first application programs and said plurality of second application programs, one combination of said one first application program and said one second application program which takes the shortest amount of total processing time required for an operating conditions reflection executed by said configuration part for allowing said first function to operate and an operating conditions reflection executed by said configuration part for allowing said second function to operate; and
an application execution part for allowing said first function to operate with execution of said one first application program and for allowing said second function to operate with execution of said one second application program after operation of said first function based on said one combination selected by said application management part.

6. The information processing device according to claim 5, further comprising:
a manipulation part for receiving an operation to specify the operating conditions for each of said first function and said second function made by a user, wherein
when selecting said one combination of said one first application program and said one second application program, said application management part selects said one first application program from at least one first application program which satisfies the operating conditions specified for said first function by the user and said one second application program from at least one second application program which satisfies the operating conditions specified for said second function by the user.

7. The information processing device according to claim 5, wherein
said application management part selects in preference the combination of the first application program and the second application program capable of allowing said first function and said second function to operate sequentially without change of the current setting configured by said configuration part.

8. The information processing device according to claim 7, wherein
when the number of the combination of the first application program and the second application program capable of allowing said first function and said second function to operate sequentially without change of the current setting configured by said configuration part is more than one, said application management part prompts the user to make an operation to select said one combination and selects said one combination specified by the user.

9. An application execution method, comprising the steps of:
(a) storing a plurality of application programs allowing a specified function to operate under operating conditions differ among said plurality of application programs;
(b) managing the respective operating conditions of said plurality of application programs, obtaining a current setting corresponding to said specified function for allowing said specified function to operate and selecting, based on the respective operating conditions of said plurality of application programs, one application program which takes the shortest amount of processing time required for an operating conditions reflection executed to allow said specified function to operate;
(c) configuring a setting to reflect the operating conditions corresponding to said one application program selected from said plurality of application programs; and
(d) allowing said specified function to operate with execution of said one application program selected from said plurality of application programs.

10. The application execution method according to claim 9, further comprising the step of:
(e) receiving an operation to specify the operating conditions for said specified function made by a user, wherein
in said step (b), said one application program which takes the shortest amount of processing time required for the operating conditions reflection executed in said step (c) is selected from at least one application program which satisfies the operating conditions specified by the user.

11. The application execution method according to claim 9, wherein
in said step (b), the application program capable of being executed without change of the current setting configured in said step (c) is selected in preference.

12. The application execution method according to claim 11, wherein
when the number of the application program capable of being executed without change of the current setting configured in said step (c) is more than one, said step (b) prompts the user to make an operation to select said one application program and selects said one application program specified by the user.

13. An application execution method for executing a series of processes by executing each application program corresponding to a first function and a second function sequentially, comprising the steps of:
(a) storing a plurality of first application programs allowing said first function to operate under operating conditions differ among said plurality of first application programs and a plurality of second application programs allowing said second function to operate under operating conditions differ among said plurality of second application programs;
(b) managing the respective operating conditions of said plurality of first application programs and said plurality of second application programs, obtaining in advance a current setting corresponding to each of said first function and said second function when said first function and said second function are allowed to operate sequentially and selecting, based on the respective operating conditions of said plurality of first application programs and said plurality of second application programs, one combination of one first application program and one second application program which takes the shortest amount of total processing time required for an operating conditions reflection executed for allowing said first function to operate and an operating conditions reflection executed for allowing said second function to operate;
(c) configuring a setting to reflect the operating conditions corresponding to said one first application program of said one combination for allowing said first function to operate and for configuring a setting to reflect the operating conditions corresponding to one second application program of said one combination for allowing said second function to operate; and
(d) allowing said first function to operate with execution of said one first application program of said one combination and for allowing said second function to operate with execution of said one second application program of said one combination after operation of said first function.

14. The application execution method according to claim 13, further comprising:
(e) receiving an operation to specify the operating conditions for said first function and said second function made by a user, wherein
when said one combination of said one first application program and said one second application program is selected, said one first application program is selected from at least one first application program which satisfies the operating conditions specified for said first function by the user and said one second application program is selected from at least one second application program which satisfies the operating conditions specified for said second function by the user in said step (b).

15. The application execution method according to claim 13, wherein
in said step (b), the combination of the first application program and the second application program capable of allowing said first function and said second function to operate sequentially without change of the current setting configured in said step (c) is selected in preference.

16. The application execution method according to claim 15, wherein
when the number of the combination of the first application program and the second application program capable of allowing said first function and said second function to operate sequentially without change of the current setting configured in said step (c) is more than one, said step (b) prompts the user is prompted to make an operation to select said one combination and selects said one combination specified by the user.

17. A computer readable recording medium on which an application management program is recorded, said application management program selecting one application program of a plurality of application programs in an information processing device on which said plurality of application programs allowing a specified function to operate under operating conditions differ among said plurality of application programs when allowing said specified function to operate are installed, said application management program causing said information processing device to execute the steps of:
(a) configuring a setting to reflect the operating conditions corresponding to said one application program selected from said plurality of application programs;
(b) managing the respective operating conditions of said plurality of application programs, obtaining a current setting configured in said step (a) when said specified function is allowed to operate and selecting, based on the respective operating conditions of said plurality of application programs, one application program which takes the shortest amount of processing time required for an operating conditions reflection executed in said step (a); and
(c) allowing said specified function to operate with execution of said one application program selected in said step (b).

18. The computer readable medium according to claim 17, wherein said application management program causes said information processing device to further execute the step of:
(e) receiving an operation to specify the operating conditions for said specified function made by a user,
in said step (b), said one application program which takes the shortest amount of processing time required for the operating conditions reflection executed in said step (a) is selected from at least one application program which satisfies the operating conditions specified by the user.

19. The computer readable medium according to claim 17, wherein
in said step (b), the application program capable of being executed without change of the current setting configured in said step (a) is selected in preference.

20. The computer readable medium according to claim 19, wherein
when the number of the application program capable of being executed without change of the current setting configured in said step (a) is more than one, said step (b) prompts the user to make an operation to select said one application program and selects said one application program specified by the user.

21. A computer readable recording medium on which an application management program is recorded, said application management program selecting one of a plurality of first application programs and one of a plurality of second application programs in an information processing device on which said plurality of first application programs allowing a first function to operate under operating conditions differ among said plurality of first application programs and said plurality of second application programs allowing a second function to operate under operating conditions differ among said plurality of second application programs are installed when allowing said first function and said second function to operate sequentially, said application management program causing said information processing device to execute the steps of:
(a) configuring a setting to reflect the operating conditions corresponding to said one first application program selected from said plurality of first application programs for allowing said first function to operate and for configuring a setting to reflect the operating conditions corresponding to said one second application program selected from said plurality of second application programs for allowing said second function to operate;
(b) managing the respective operating conditions of said plurality of first application programs and said plurality of second application programs, obtaining in advance a current setting configured in said step (a) when said first function and said second function are allowed to operate sequentially and selecting, based on the respective operating conditions of said plurality of first application programs and said plurality of second application programs, one combination of said one first application program and said one second application program which takes the shortest amount of total processing time required for an operating conditions reflection executed in said step (a) for allowing said first function to operate and an operating conditions reflection executed in said step (a) for allowing said second function to operate; and
(c) allowing said first function to operate with execution of said one first application program and for allowing said second function to operate with execution of said one second application program after operation of said first function based on said one combination selected in said step (b).

22. The computer readable medium according to claim 21, wherein said application management program causes said information processing device to further execute the step of:
(d) receiving an operation to specify the operating conditions for said first function and said second function made by a user,
when said one combination of said one first application program and said one second application program is selected, said one first application program is selected from at least one first application program which satisfies the operating conditions specified for said first function by the user and said one second application program is selected from at least one second application program which satisfies the operating conditions specified for said second function by the user in said step (b).

23. The computer readable medium according to claim 21, wherein
in said step (b), the combination of the first application program and the second application program capable of allowing said first function and said second function to operate sequentially without change of the current setting configured in said step (a) is selected in preference.

24. The computer readable medium according to claim 23, wherein
when the number of the combination of the first application program and the second application program capable of allowing said first function and said second function to operate sequentially without change of the current setting configured in said step (a) is more than one, said step (b) prompts the user to make an operation to select said one combination and selects said one combination specified by the user.
